(19) United States
(12) Patent Application Publication
(10) Pub. No.: US 2015/0015003 A1
(43) Pub. Date: Jan. 15, 2015

(54) CONCEALED FASTENER LOCKSET

(71) Applicants: PING HSIEN TSAI, Walnut, CA (US); Birk Cliff Sorensen, Whittier, CA (US)

(72) Inventors: PING HSIEN TSAI, Walnut, CA (US); Birk Cliff Sorensen, Whittier, CA (US)

(21) Appl. No.: 13/940,178

(22) Filed: Jul. 11, 2013

(51) Int. Cl. E05C 3/14

(52) U.S. Cl. CPC E05C 3/145
USPC 292/336.3

(57) ABSTRACT

Locksets primarily intended for use in interior residential doors and that have a concealed fastener mechanism positioned on one side of the lockset, the mechanism including connecting a first handle connected to a second handle through a spindle with the concealed fastener mechanism comprising a generally cylindrical housing including a torsion spring, a timing plate and a cover plate, the housing including an internally threaded central aperture, the timing plate including at least one tab adapted to cooperate with said torsion spring to return the handle to its at-rest position after rotation.

### CROSS REFERENCE TO RELATED APPLICATION

This application claims the benefit of priority on U.S. provisional patent application 61/672,259, filed Jul. 16, 2012, and is incorporated by reference herein.

### FIELD OF INVENTION

The invention relates to the field of door locksets, including but not limited to interior doors such as interior passage and privacy locksets.

### BACKGROUND

Typical conventional door passage locksets include a handle that may be a knob or a lever, a spindle, a rosette on each side of the door and mounting screws that hold the lockset together and that are exposed on one of the rosettes.

### SUMMARY

The present concealed fastener locksets include a concealed fastener mechanism that may be used with conventional knob and lever locksets and that conceal the mounting screws on the rosette. The present concealed lockset mechanisms provide for sleek, concealed fastener systems with no exposed screws and that can be used in brass, stainless steel, bronze, zinc, steel, aluminum, crystal and porcelain interior passage and privacy locksets. The present locksets include a concealed fastener cartridge adapted for use with a knob handle, and a cartridge adapted for use with a lever handle. Both types of locksets accommodate a privacy feature.

Numerous features, aspects, and advantages of the present concealed fastener locksets will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a perspective, exploded view of a preferred embodiment of the present concealed fastener lockset assembly including a display block;

FIG. 2 is a perspective, exploded view of the lockset assembly of FIG. 1;

FIG. 3 is a close up, perspective, exploded view of the concealed fastener mechanism of the FIG. 1 embodiment;

FIG. 4 is a close up, perspective, exploded view of a concealed fastener mechanism for an alternate concealed fastener lockset embodiment;

FIG. 5A is a perspective view of the concealed fastener lockset spindle assembly disassembled;

FIG. 5B is a perspective view of the FIG. 5A concealed fastener lockset spindle assembly assembled;

FIG. 5C is a cross-sectional view of the FIG. 5A concealed fastener lockset spindle assembly;

FIG. 5D is a view of the joining regions of the FIG. 5A concealed fastener lockset spindle assembly encircled in FIG. 5C;

Reference symbols or names are used in the figures to indicate certain components, aspects or features shown therein. Reference symbols common to more than one figure are 4825-4538-9584.2 2 specific to the referenced figure and may or may not indicate like components, aspects or features shown in other figures.

### DETAILED DESCRIPTION

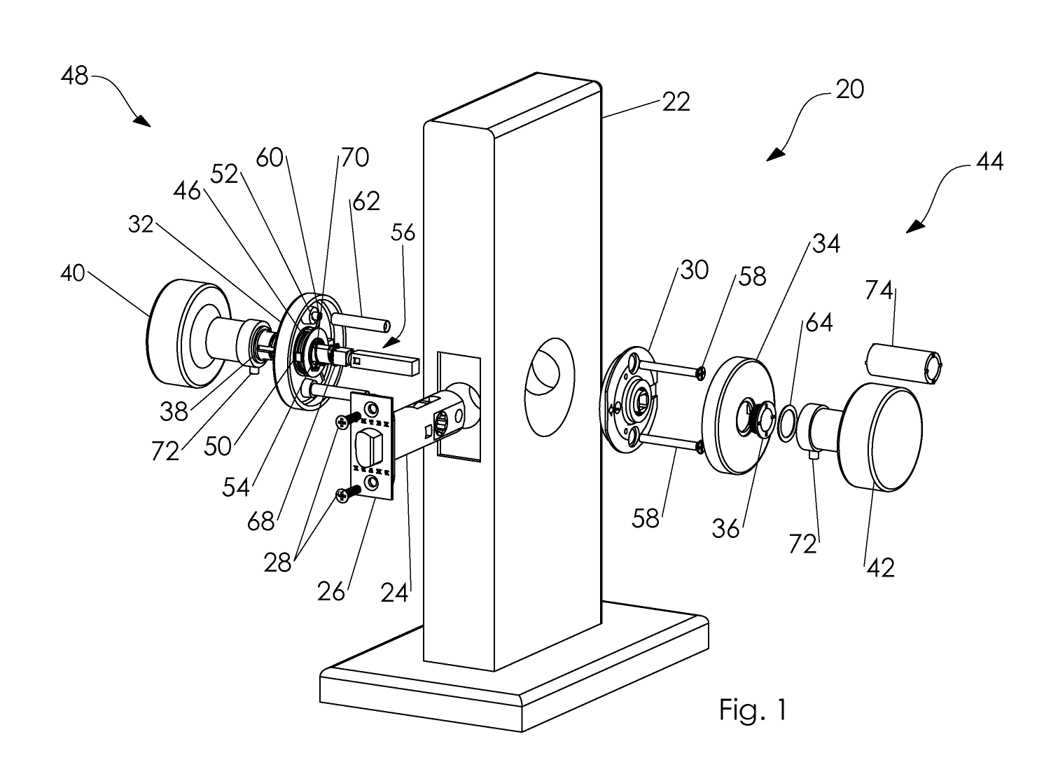

With reference to FIG. 1 a complete assembly of a preferred embodiment 20 of the present concealed fastener locksets is shown. For convenience and ease of reference the lockset 20 is shown placed in a display block 22, which in normal consumer use would be an entire, interior door. Latch 24 and face plate 26 are shown as adapted to be inserted into the display block 22 and retained in the block with conventional Phillips screws 28.

A preferred embodiment concealed fastener mechanism cartridge is shown at 30. The cartridge 30 may also be referred to as a cassette 30, but for convenience and consistency will be referred to as a cartridge. The cartridge 30 is positioned on a “concealed side” of the door, which can be “inside” or “outside” relative to other structures of the home or other building in which the door is positioned. For example, in residential use the cartridge 30 could be placed on either side of the door. The FIG. 1 embodiment lockset and its cartridge 30 are for use with a knob lockset. An alternate preferred embodiment lockset and cartridge are for use with a lever lockset. Rosette 32 is positioned on the un-concealed side of the door, and a corresponding rosette 34 is positioned on the concealed side of the door. Rosette fastener ring nut 36 is externally threaded and is adapted to be screwed into the cartridge 30, causing the rosette 34 to abut against the door.

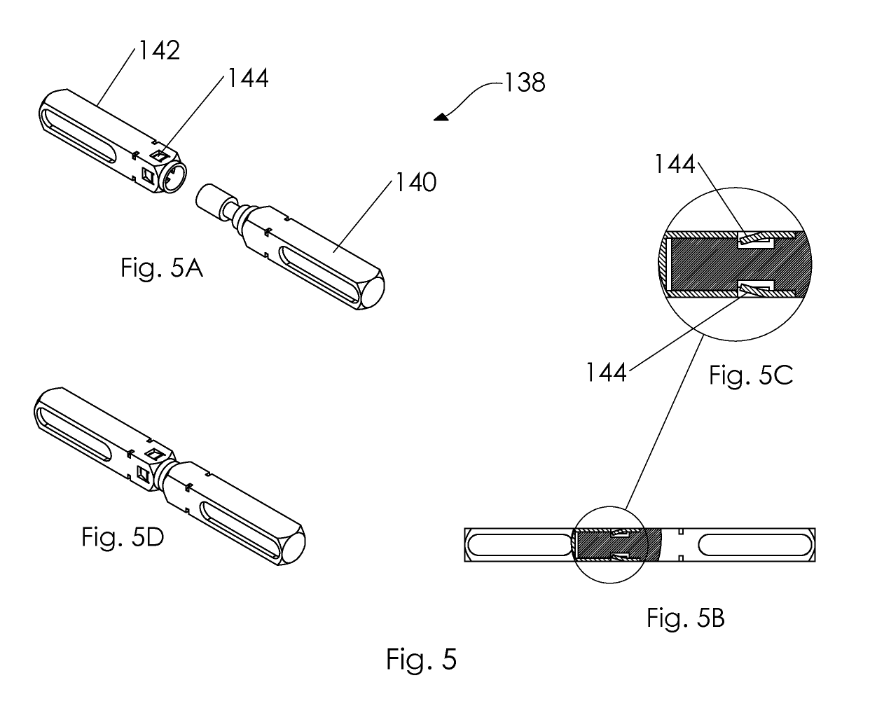

Conventional shoulder washer 38 and knob 40 are shown on the un-concealed side of the door. Knob 42 is on the concealed side of the door and is adapted to be used with the concealed fastener mechanism 44. Shim spacer 46 is in the knob assembly 48 on the un-concealed side. Timing plate 50 is also positioned on that side and it functions to hold down rotational return spring 52. Conventional c-clip 54 holds the knob assembly 48 together. Concealed fastener split spindle assembly is generally shown at 56 and with details shown in FIGS. 5A-5D.

Pairs of machine screws 58, set screw sockets 60 and socket posts 62 function to hold the two knob assemblies together. Washer 64, preferably made of a relatively hard, elastomeric material functions to reduce friction on knob 42 as it is rotated in either direction. Set screw 66 functions to retain knob 42 on the spindle 56 on the concealed side of the lockset. Preferably the set screw 66 is for use with an Allen wrench.

Conventional spindle clip 68 on the spindle 56 functions to set the distance that the spindle is inserted into the latch 24. Cone spring 70 functions to bias the spindle 56 away from knob 40 and toward knob 42. Set screw 72 is positioned in knob 40 and serves two functions. First set screw 72 prevents spindle 56 from escaping from knob 40, while permitting limited reciprocation of the spindle 56. Secondly, once spindle 56 has been inserted through the latch 24 mounted in the door and c-clip 54 abuts against latch 24, then set screw 72 is tightened down to secure spindle 56 for proper operation of the lock. The thickness of the particular door determines when the c-clip 54 abuts against latch 24. With a relatively thin door, relatively more of the spindle will be contained within the knob 40, and with a relatively thick door relatively less of the spindle will be contained within the knob 40 after the screw 72 has been tightened.

Tool 74 is adapted to rotate to tighten or loosen and remove rosette ring nut 36. Tool 74 is preferably made of a polymeric material that is of sufficient strength to enable hand tightening of the ring nut 36. Tool 74 may have two or more flat surfaces to enable operation with pliers or a wrench. As shown in FIG. 1 rosette ring nut 36 has four rectangular-shaped female indentations located 90° apart from each other, and tool 74 has four corresponding, complementary male protrusions adapted for cooperation with the indentations on the ring nut 36. Other complementary shapes and forms may be used.

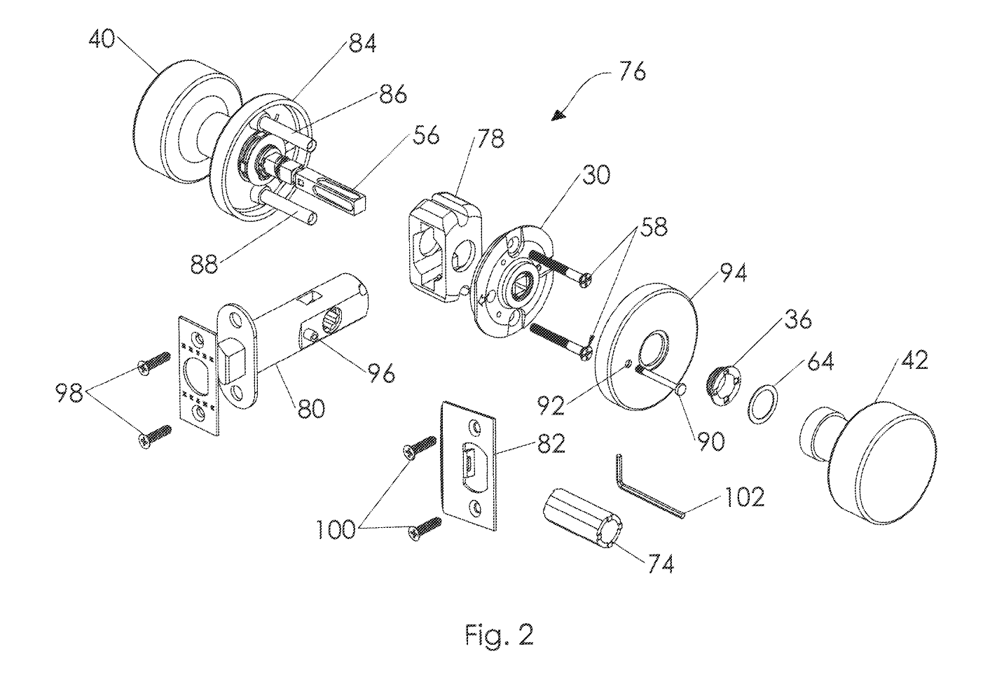

Referring to FIG. 2, an exploded view of an alternate embodiment 76 of the concealed fastener mechanism is shown, including the addition of a preferred post alignment device 78, a privacy latch 80 and a strike plate 82. The FIG. 2 post alignment device 78 is preferably of a sturdy polymeric material. The device 78 functions to keep privacy rosette 84 from rotating during use, and is adapted to secure the latch 80 and to align the posts 86, 88 along the top and bottom grooves of the device 78.

Again referring to FIG. 2, the privacy assembly includes privacy pin 90 which extends through a hole 92 in the rosette 94 and threads into the privacy latch 80 at the privacy latch trigger shown at 96. The FIG. 2 latch 80 is fastened to the door with wood screws 98. FIG. 2 also shows conventional strike plate 82 and wood screws 100, preferably of the same type and size as the wood screws 98 used for the latch 80. The FIG. 2 latch 80 differs from the FIG. 1 latch 24 in that the FIG. 2 latch 80 includes the privacy assembly and preferably is a 28° rotation latch. The FIGS. 1 and 2 latches 24, 80 may also provide for different degrees of rotation required to latch and unlatch the lockset. Preferably the FIG. 2 latch 80 is configured to latch and unlatch with a 28° rotation. Conventional latches also typically are made to operate with a rotation in the range of 45°-60°, for example a 50° rotation. The privacy pin 90 operates simply by pushing to lock the door. As the door handle (knob or lever) is rotated from the same side, the privacy mechanism operates to unlock the latch so that there is no need to withdraw the pin 90. Allen wrench 102 is shown in FIG. 2, and may be used to tighten or loosen the set screws in the handles of the locksets. Tool 74 is also shown in FIG. 2 and is described with respect to FIG. 1.

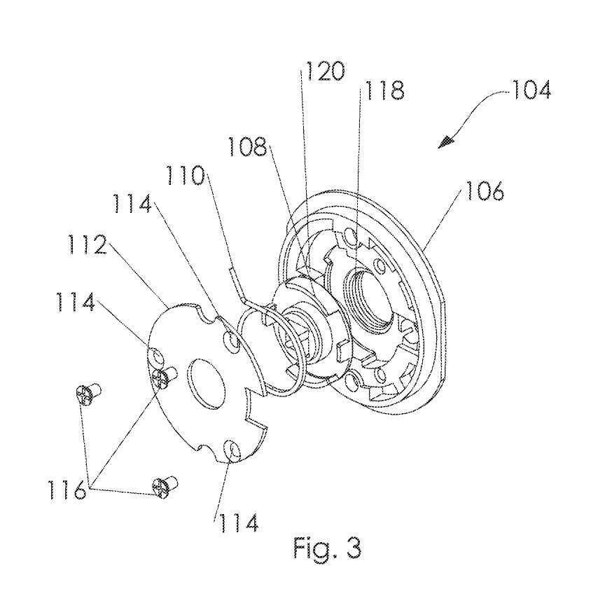

Referring to FIG. 3 an exploded view of a preferred cartridge spring assembly 104 for use with a knob is shown. Concealed fastener spring housing 106 houses knob timing plate 108 and knob spring 110. The spring 110 and plate 108 are held in place by cover plate 112 having three holes 114 and three machine screws 116. The housing 106 includes internal threads 118 to accommodate the external threads of the rosette ring nut 36.

The knob timing plate 108 functions to keep the spindle 56 aligned with latches 24 and 80. The distal end of spring 110 extends at a right angle from the periphery of the spring 110 and functions as a stop to rest against shoulder 120 in the housing 106.

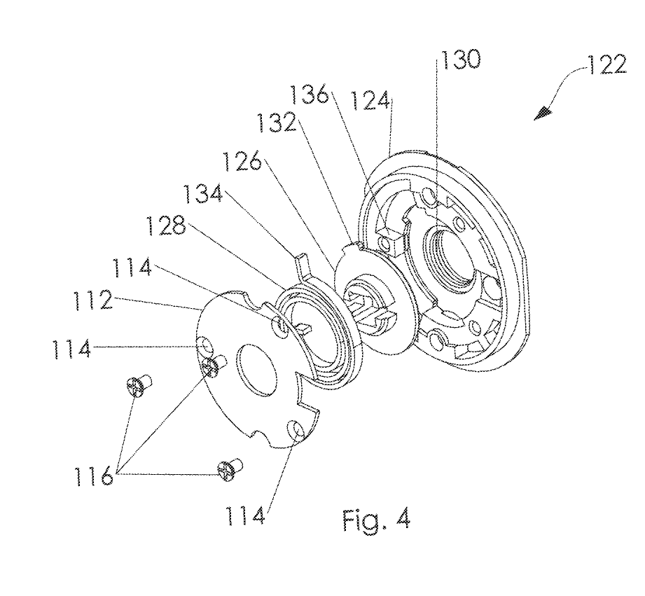

With reference to FIG. 4, a preferred cartridge spring assembly 122 for use with a lever is shown. Concealed fastener spring housing 124 houses lever timing plate 126 and lever return spring 128. Spring housing 124 for the lever embodiment is preferably of the same construction as the spring housing 106 for the knob embodiment shown in FIG. 3. Again referring to FIG. 4, the timing plate 126 and spring 128 are held in place by housing cover plate 112, having three holes 114 and three machine screws 116. The lever spring housing 124 includes internal threads 130 to accommodate the external threads of the rosette ring nut 36 of FIGS. 1 and 2. The timing plate 126 for the lever embodiment is of a different construction than the timing plate 108 for the knob embodiment. The FIG. 4 lever timing plate 126 preferably has a single tooth or projection 132. In one preferred embodiment the tooth 132 is adapted for only a 28° rotation for latching/unlatching. Conventional coil spring 128 has a distal end 134 which extends 90° from the outer coil of the spring 128 and abuts either side of shoulder 136 in the housing 124.

Referring to FIGS. 5A, B, C and D, a preferred concealed fastener spindle assembly 138 is shown. FIG. 5A shows the disassembled split spindle male member 140 and female member 142 showing four rectangular tabs, one of which is shown at 144. Each of the tabs 144 has three sides cut-out and one side attached to its top surface. Preferably, such tabs 144 are included on the top, bottom and both sides of the female member 142. FIG. 5B is a cross-sectional view of the assembled spindle assembly 138, showing two of the four tabs crimped inward toward the center, and FIG. 5C is a close-up, showing the crimped tabs 144 in greater detail. The crimped tabs 144 function to permit rotation of the two spindle members 140, 142 relative to each other, and to prevent the two members from separating from each other during normal use. FIG. 5D shows the assembled split spindle 138. The split spindle is preferably used for both the knob and lever embodiments of the concealed fastener locksets.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A concealed fastener lockset comprising:
a latch;
a spindle operatively connected to said latch;
a first handle operatively connected to said latch;
a first rosette positioned on said first handle and adapted to abut against a door;
a second handle operatively connected to said latch;
a second rosette positioned on said second handle and adapted to abut against said door; and,
a concealed fastener mechanism connecting said first handle to said second handle through said spindle;
said concealed fastener mechanism comprising a generally cylindrical housing, a torsion spring, a generally circular timing plate and a cover plate;
said housing including an internally threaded central aperture;
said housing including two arc-shaped cavities, each cavity extending through an arc of rotation; and,
said timing plate including at least one tab adapted to cooperate with said torsion spring to return said handle to its at-rest position after rotation.
